(19) United States
(12) Patent Application Publication
(10) Pub. No.: US 2021/0373576 A1
(43) Pub. Date: Dec. 2, 2021

(54) CONTROL METHOD OF ROBOT SYSTEM

(71) Applicant: LG ELECTRONICS INC., Seoul (KR)

(72) Inventor: Byungkuk SOHN, Seoul (KR)

(73) Assignee: LG Electronics Inc., Seoul (KR)

(21) Appl. No.: 16/978,607

(22) PCT Filed: Jan. 3, 2019
(86) PCT No.: PCT/KR2019/000083

§ 371 Date: Sep. 4, 2020

(51) Int. Cl. G05D 1/02; G05B 19/4155; G05D 1/00

(52) U.S. Cl. CPC G05D 1/0297; G05B 2219/50391; G05D 1/0088; G05B 19/4155

(57) ABSTRACT

Disclosed is a method of controlling a robot system, including recognizing identification information of a user, by a first robot, transmitting a recognition result of the identification information of the user to a server system including one or more servers, by the first robot, receiving user input including a shopping cart service request from the user, by the first robot, transmitting information based on the user input to the server system, by the first robot, determining a support robot for supporting a task corresponding to the service request, by the server system, making a request to a second robot identified to be the support robot for the task, by the server system, and performing the task, by the second robot.

### CROSS-REFERENCE TO RELATED APPLICATION

This application is the National Phase of PCT International Application No. PCT/KR2019/000083 filed on Jan. 3, 2019, the entirety of which is hereby expressly incorporated by reference into the present application.

### TECHNICAL FIELD

The present disclosure relates to a robot system and a method of controlling the same, and more particularly to a robot system capable of performing cooperative work using a plurality of robots and providing various services and a method of controlling the same.

### BACKGROUND ART

Robots have been developed for industrial use to administrate some parts of factory automation. Recently, the application fields of robots have further expanded, leading to the development of medical robots, aerospace robots, etc. and the manufacture of robots used in general homes for domestic uses. Among such robots, an autonomous mobile robot is referred to as a mobile robot.

With the increase in the use of robots, the demand for robots capable of providing various types of information, entertainment, and services in addition to the repeated performance of simple functions has increased.

Accordingly, robots for use in a home, stores, and public facilities so as to communicate with people are being developed.

In addition, services using a mobile robot that is capable of autonomously traveling have been proposed. For example, the cited reference (Korean Patent Application Publication No. 10-2008-0090150, Published on Oct. 8, 2008) proposes a service robot capable of providing a service based on a current position thereof while moving in a service area, a service system using the service robot, and a method of controlling the service system using the service robot.

However, although the number and type of proposed robots increase, the operation and service that is capable of being performed by a single robot has been intensively researched and developed.

Therefore, there is a need for a system for cooperation between robots that is capable of providing various services to customers using a plurality of robots and that is improved in terms of cost and efficiency.

### DISCLOSURE

### Technical Problem

It is an object of the present disclosure to provide a robot system capable of providing various services using a plurality of robots and a method of controlling the same.

It is another object of the present disclosure to provide a low-cost, high-efficiency robot system capable of minimizing intervention of an administrator and a method of controlling the same.

It is another object of the present disclosure to provide a robot system capable of efficiently providing the optimal service using different types of robots and a method of controlling the same.

It is another object of the present disclosure to provide a robot system capable of selecting a combination suitable for the type of the service and a place at which a service is provided and providing the service using a minimum number of robots and a method of controlling the same.

It is another object of the present disclosure to provide a robot system capable of effectively administrating a plurality of robots and a method of controlling the same.

It is another object of the present disclosure to provide a robot system capable of using data acquired through a plurality of robots and a method of controlling the same.

It is a further object of the present disclosure to provide a robot system operatively associated with an external server to provide various services and a method of controlling the same.

### Technical Solution

In accordance with an aspect of the present disclosure, the above and other objects can be accomplished by the provision of a robot system and a method of controlling the same, wherein a plurality of robots cooperates with each other and provides various services. In particular, different types of robots can be used to provide the optimal service satisfying the request of a customer.

In accordance with an aspect of the present disclosure, the above and other objects can be accomplished by the provision of a method of controlling a mobile robot, including recognizing identification information of a user, by a first robot, transmitting a recognition result of the identification information of the user to a server system including one or more servers, by the first robot, receiving user input including a shopping cart service request from the user, by the first robot, transmitting information based on the user input to the server system, by the first robot, determining a support robot for supporting a task corresponding to the service request, by the server system, making a request to a second robot identified to be the support robot for the task, by the server system, and performing the task, by the second robot.

In the making the request, the server system transfers previous shopping information of the user to the second robot, and in the performing the task, the second robot moves based on the previous shopping information of the user, and thus a customized shopping service can be provided to the customer.

In accordance with another aspect of the present disclosure, a method of controlling a mobile robot includes outputting a guidance message for guidance for recommended shopping information, by a first robot, receiving user input for making a request for a service based on recommended shopping information from a user, by the first robot, transmitting information based on the user input to the server system, by the first robot, determining a support robot for supporting a task corresponding to the service request, by the server system, making a request to a second robot identified to be the support robot for the task, by the server system, and performing the task, by the second robot.

In accordance with another aspect of the present disclosure, a method of controlling a mobile robot includes receiving user input including a shopping cart service request from a user, by a first robot, determining a support robot for supporting a task corresponding to the service request, by the first robot, making a request to a second robot identified to be the support robot for the task, by the first robot, and performing the task, by the second robot, wherein, in the making the request, the first robot transfers recommended shopping information or previous shopping information of the user to the second robot, and in the performing the task, the second robot moves based on the recommended shopping information or the previous shopping information of the user.

The server system can check user information corresponding to identification information of the user and can use user information including previous shopping information of the user.

The server system can include a first server configured to control a robot and a second server configured to administrate user information, and when the first server checks user information corresponding to identification information of the user from a database and transfers the user information to the second server, the second server can determine the support robot and can transfer previous shopping information of the user to the second robot, and thus can effectively assign tasks between servers.

If necessary, the second robot can move to a position in which the first robot is positioned and then can support shopping of the user.

Alternatively, the second robot can move to a waiting place based on the previous shopping information of the user and can support shopping of the user. In this case, the first robot can output a guidance message indicating a current waiting state when the second robot stands by at the waiting place for a task for supporting shopping of the user, if there is predetermined user input of another person.

In some embodiments, the making the request can include further transmitting identification image information for identifying the user to the second robot, by the server system, and the identification image information can be image data obtained through photography by the first robot and transmitted to the server system or image data registered in the server system by the user.

The first robot and the second robot can be different types. For example, the first robot can be a guide robot configured to provide guidance for predetermined shopping information to a user, and the second robot can be a delivery robot that moves while carrying a shopping article of the user.

### Advantageous Effects

According to at least one of the embodiments of the present disclosure, various services can be provided using a plurality of robots, thereby improving use convenience.

According to at least one of the embodiments of the present disclosure, a low-cost, high-efficiency system for cooperation between robots capable of minimizing intervention of an administrator can be embodied.

According to at least one of the embodiments of the present disclosure, the optimal service can be efficiently provided using different types of robots.

According to at least one of the embodiments of the present disclosure, a combination suitable for the type of the service and a place at which a service is provided can be selected and the service can be provided using a minimum number of robots.

According to at least one of the embodiments of the present disclosure, a plurality of robots can be effectively administered and data acquired through a plurality of robots can be used.

In addition, according to at least one of the embodiments of the present disclosure, a robot system that is operatively associated to an external server to provide various services can be embodied.

Various other effects of the present disclosure will be directly or suggestively disclosed in the following detailed description of the disclosure.

### DESCRIPTION OF DRAWINGS

FIG. 1 is a diagram illustrating the construction of a robot system according to an embodiment of the present disclosure.

FIGS. 2A to 2D are reference diagrams illustrating a robot service delivery platform included in the robot system according to the embodiment of the present disclosure.

FIG. 3 is a reference diagram illustrating learning using data acquired by a robot according to an embodiment of the present disclosure.

FIGS. 4, 5, and 6A to 6D are diagrams illustrating robots according to embodiments of the present disclosure.

FIG. 7 illustrates an example of a simple internal block diagram of a robot according to an embodiment of the present disclosure.

FIG. 8A is a reference diagram illustrating a system for cooperation between robots via a server according to an embodiment of the present disclosure.

FIG. 8B is a reference diagram illustrating a system for cooperation between robots according to an embodiment of the present disclosure.

FIG. 9 is a flowchart illustrating a method of controlling a robot system according to an embodiment of the present disclosure.

FIG. 10 is a flowchart illustrating the case in which shopping is supported in a big-box store according to an embodiment of the present disclosure.

FIG. 11 is a flowchart illustrating a method of controlling a robot system according to an embodiment of the present disclosure.

FIG. 12 is a flowchart illustrating a method of controlling a robot system according to an embodiment of the present disclosure.

FIG. 13 is a flowchart illustrating a method of controlling a robot system according to an embodiment of the present disclosure.

FIGS. 14 to 17 are reference diagrams illustrating the operation of a robot system according to an embodiment of the present disclosure.

### BEST MODE

Reference will now be made in detail to embodiments, examples of which are illustrated in the accompanying drawings. However, the present disclosure can be embodied in many different forms and should not be construed as being limited to the embodiments set forth herein.

In the following description, with respect to constituent elements used in the following description, the suffixes “module” and “unit” are used or combined with each other only in consideration of ease in the preparation of the specification, and do not have or indicate mutually different meanings. Accordingly, the suffixes “module” and “unit” can be used interchangeably.

It will be understood that although the terms “first,” “second,” etc., can be used herein to describe various components, these components may not be limited by these terms. These terms are only used to distinguish one component from another component.

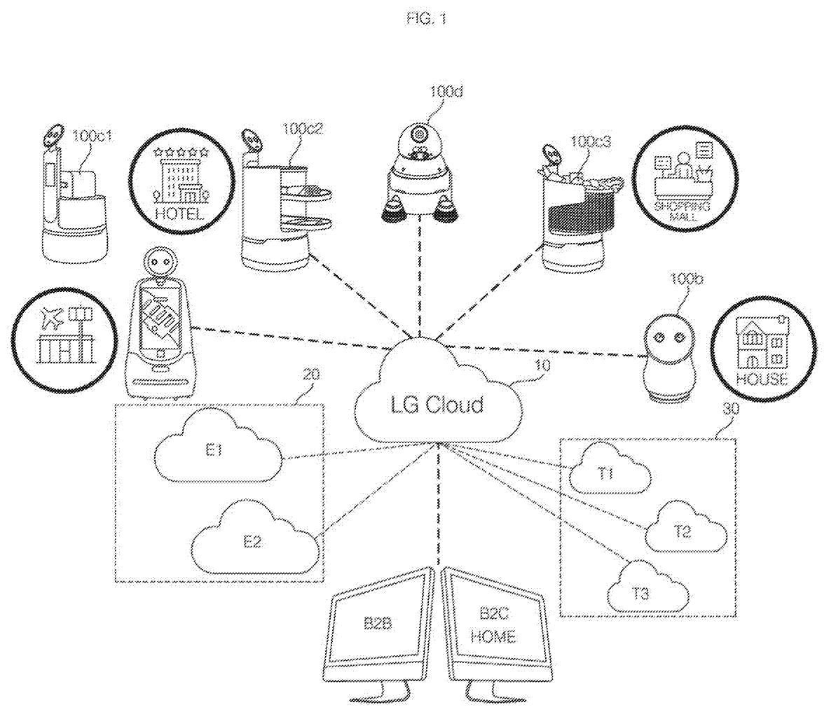

FIG. 1 is a diagram illustrating the configuration of a robot system according to an embodiment of the present disclosure.

Referring to FIG. 1, the robot system 1 according to an embodiment of the present disclosure can include one or more robots 100a, 100b, 100c1, 100c2, and 100c3 and can provide services at various places, such as an airport, a hotel, a big-box store, a clothing store, a logistics center, and a hospital. For example, the robot system 1 can include at least one of a guide robot 100a for providing guidance for a specific place, article, and service, a home robot 100b for interacting with a user at home and communicating with another robot or electronic device based on user input, delivery robots 100c1, 100c2, and 100c3 for delivering specific articles, or a cleaning robot 100d for performing cleaning while autonomously traveling.

In detail, the robot system 1 according to an embodiment of the present disclosure includes a plurality of robots 100a, 100b, 100c1, 100c2, 100c3, and 100d and a server 10 for administrating and controlling the plurality of robots 100a, 100b, 100c1, 100c2, 100c3, and 100d.

The server 10 can remotely monitor and control the state of the plurality of robots 100a, 100b, 100c1, 100c2, 100c3, and 100d, and the robot system 1 can provide more effective services using the plurality of robots 100a, 100b, 100c1, 100c2, 100c3, and 100d.

In more detail, the robot system 1 can include various types of robots 100a, 100b, 100c1, 100c2, 100c3, and 100d. Accordingly, services can be provided through the respective robots, and more various and convenient services can be provided through cooperation between the robots.

The plurality of robots 100a, 100b, 100c1, 100c2, 100c3, and 100d and the server 10 can include a communication element that supports one or more communication protocols and can communicate with each other. In addition, the plurality of robots 100a, 100b, 100c1, 100c2, 100c3, and 100d and the server 10 can communicate with a PC, a mobile terminal, or another external server.

For example, the plurality of robots 100a, 100b, 100c1, 100c2, 100c3, and 100d and the server 10 can communicate with each other using a message queuing telemetry transport (MQTT) scheme.

Alternatively, the plurality of robots 100a, 100b, 100c1, 100c2, 100c3, and 100d and the server 10 can communicate with each other using a hypertext transfer protocol (HTTP) scheme.

In addition, the plurality of robots 100a, 100b, 100c1, 100c2, 100c3, and 100d and the server 10 can communicate with a PC, a mobile terminal, or another external server using the HTTP or MQTT scheme.

Depending on the cases, the plurality of robots 100a, 100b, 100c1, 100c2, 100c3, and 100d and the server 10 can support two or more communication protocols, and can use the optimal communication protocol depending on the type of communication data or the type of device participating in communication.

The server 10 can be embodied as a cloud server, whereby a user can use data stored in the server and a function or service provided by the server 10 using any of various devices, such as a PC or a mobile terminal, which is connected to the server 10. The cloud server 10 can be operatively connected to the robots 100a, 100b, 100c1, 100c2, 100c3, and 100d and can monitor and control the robots 100a, 100b, 100c1, 100c2, 100c3, and 100d to remotely provide various solutions and content.

The user can check or control information on the robots 100a, 100b, 100c1, 100c2, 100c3, and 100d in the robot system using the PC or the mobile terminal.

In the specification, the ‘user’ can be a person who uses a service through at least one robot, and can include an individual consumer who purchases or rents a robot and uses the robot in a home or elsewhere, managers and employees of a company that provides a service to an employee or a consumer using a robot, and consumers that use a service provided by such a company. Thus, the ‘user’ can include business-to-consumer (B2C) and business-to-business (B2B) cases.

The user can monitor the state and location of the robots 100a, 100b, 100c1, 100c2, 100c3, and 100d in the robot system and can administrate content and task schedules using the PC or the mobile terminal.

The server 10 can store and administrate information received from the robots 100a, 100b, 100c1, 100c2, 100c3, and 100d and other devices.

The server 10 can be a server that is provided by the manufacturer of the robots 100a, 100b, 100c1, 100c2, 100c3, and 100d or a company engaged by the manufacturer to provide services.

The system according to the present disclosure can be operatively connected to two or more servers.

For example, the server 10 can communicate with external cloud servers 20, such as E1 and E2, and with third parties 30 providing content and services, such as T1, T2, and T3. Accordingly, the server 10 can be operatively connected to the external cloud servers 20 and with third parties 30 and can provide various services.

The server 10 can be a control server for administrating and controlling the robots 100a, 100b, 100c1, 100c2, 100c3, and 100d.

The server 10 can collectively or individually control the robots 100a, 100b, 100c1, 100c2, 100c3, and 100d. In addition, the server 10 can group at least some of the robots 100a, 100b, 100c1, 100c2, 100c3, and 100d and can perform control for each group.

The server 10 can be configured as a plurality of servers, to which information and functions are distributed, or as a single integrated server.

Because the server 10 can be configured as a plurality of servers, to which information and functions are distributed, or as a single integrated server and can administrate the overall service using the robots, the server can be called a robot service delivery platform (RSDP).

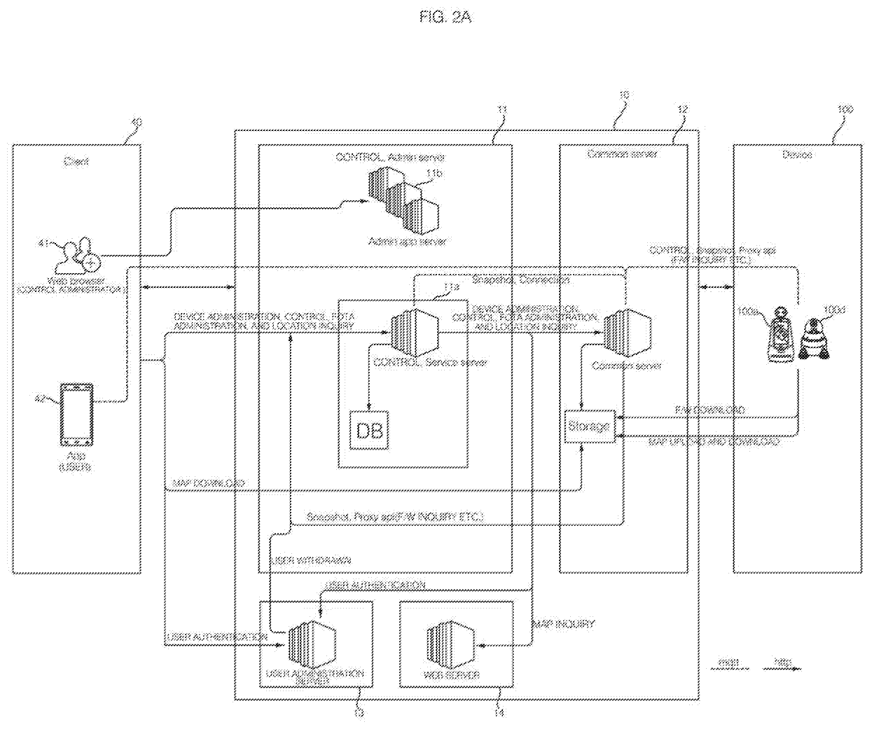

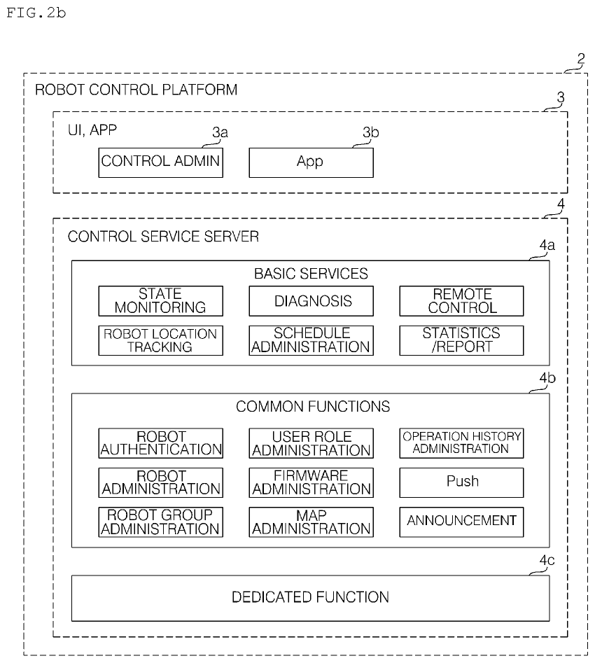

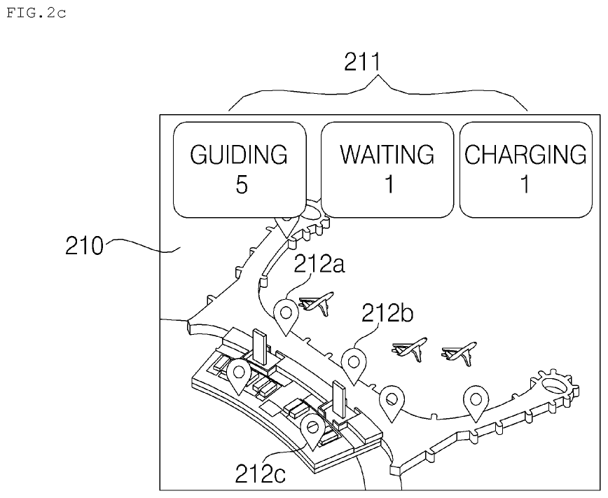

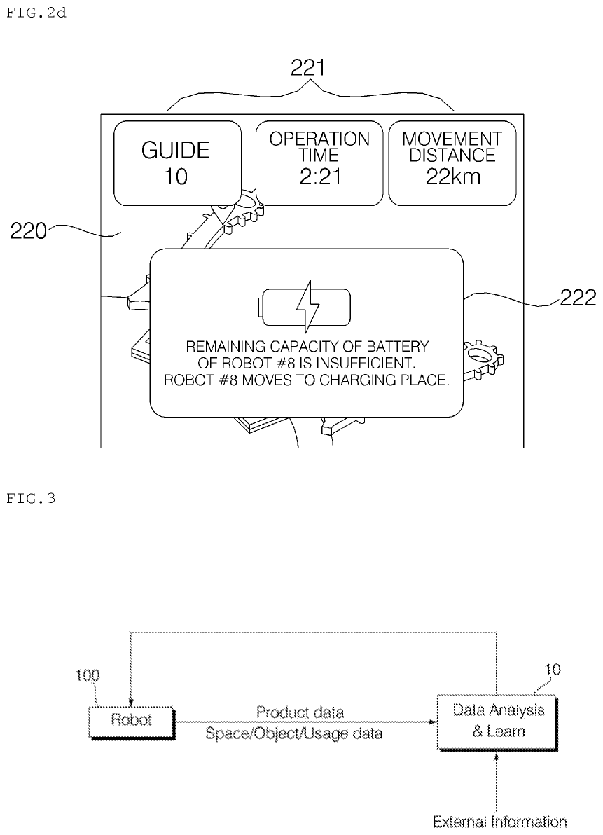

FIGS. 2A to 2D are reference diagrams illustrating a robot service delivery platform included in the robot system according to the embodiment of the present disclosure.

FIG. 2A illustrates a communication architecture of a robot service delivery platform according to an embodiment of the present disclosure.

Referring to FIG. 2A, the robot service delivery platform 10 can include one or more servers 11 and 12 and can administrate and control robots 100, such as the guide robot 100a or the cleaning robot 100d.

The robot service delivery platform 10 can include a control server 11 that communicates with a client 40 through a web browser 41 or an application 42 in a mobile terminal and administrates and controls the robots 100 and a device administration server 12 for relaying and administrating data related to the robot 100.

The control server 11 can include a control/service server 11a for providing a control service capable of monitoring the state and location of the robots 100 and administrating content and task schedules based on user input received from the client 40 and an administrator application server 11b that a control administrator is capable of accessing through the web browser 41.

The control/service server 11a can include a database, and can respond to a service request from the client 40, such as robot administration, control, firmware over the air (FOTA) upgrade, and location inquiry.

The control administrator can be capable of accessing the administrator application server 11b under the authority of the administrator, and the administrator application server can administrate functions related to the robot, applications, and content.

The device administration server 12 can function as a proxy server, can store metadata related to original data, and can perform a data backup function using a snapshot indicating the state of a storage device.

The device administration server 12 can include a storage for storing various data and a common server that communicates with the control/service server 11a. The common server can store various data in the storage, can retrieve data from the storage, and can respond to a service request from the control/service server 11a, such as robot administration, control, firmware over the air, and location inquiry.

In addition, the robots 100 can download map data and firmware data stored in the storage.

Because the control server 11 and the device administration server 12 are separately configured, it is not necessary to store data in the storage or to retransmit the data, which can be advantageous in terms of processing speed and time and effective administration can be easily achieved in terms of security.

The robot service delivery platform 10 is a set of servers that provide services related to the robot, and can mean all components excluding the client 40 and the robots 100 in FIG. 2A.

For example, the robot service delivery platform 10 can further include a user administration server 13 for administrating user accounts. The user administration server 13 can administrate user authentication, registration, and withdrawal.

In some embodiments, the robot service delivery platform 10 can further include a map server 14 for providing map data and data based on geographical information.

The map data received by the map server 14 can be stored in the control server 11 and/or the device administration server 12, and the map data in the map server 14 can be downloaded by the robots 100. Alternatively, the map data can be transmitted from the map server 14 to the robots 100 according to a request from the control server 11 and/or the device administration server 12.

The robots 100 and the servers 11 and 12 can include a communication element that support one or more communication protocols and can communicate with each other.

Referring to FIG. 2A, the robots 100 and the servers 11 and 12 can communicate with each other using the MQTT scheme. The MQTT scheme is a scheme in which a message is transmitted and received through a broker, and is advantageous in terms of low power and speed. In the case in which the robot service delivery platform 10 uses the MQTT scheme, the broker can be constructed in the device administration server 12.

In addition, the robots 100 and the servers 11 and 12 can support two or more communication protocols, and can use the optimal communication protocol depending on the type of communication data or the type of device participating in communication. FIG. 2A illustrates a communication path using the MQTT scheme and a communication path using the HTML scheme.

The servers 11 and 12 and the robots 100 can communicate with each other using the MQTT scheme irrespective of the type of the robots.

The robots 100 can transmit the current state thereof to the servers 11 and 12 through an MQTT session, and can receive remote control commands from the servers 11 and 12. For MQTT connection, a digital certificate of authentication, such as a personal key (issued for SCR generation), an X.509 certificate of authentication received at the time of robot registration, or a certificate of device administration server authentication, or other authentication schemes can be used.

In FIG. 2A, the servers 11, 12, 13, and 14 are classified based on the functions thereof. However, the present disclosure is not limited thereto. Two or more functions can be performed by a single server, and a single function can be performed by two or more servers.

FIG. 2B illustrates a block diagram of the robot service delivery platform according to the embodiment of the present disclosure, and illustrates upper-level applications of a robot control platform related to robot control.

Referring to FIG. 2B, the robot control platform 2 can include a user interface 3 and functions/services 4 provided by the control/service server 11a).

The robot control platform 2 can provide a web site-based control administrator user interface 3a and an application-based user interface 3b.

The client 40 can use the user interface 3b, provided by the robot control platform 2 through a device used by the client 40 itself.

FIGS. 2C and 2D are diagrams showing an example of a user interface provided by the robot service delivery platform 10 according to the embodiment of the present disclosure.

FIG. 2C illustrates a monitoring screen 210 related to a plurality of guide robots 100a.

Referring to FIG. 2C, the user interface screen 210 provided by the robot service delivery platform can include state information 211 of the robots and location information 212a, 212b, and 212c of the robots.

The state information 211 can indicate the current state of the robots, such as guiding, waiting, or charging.

The location information 212a, 212b, and 212c can indicate the current location of the robots on a map screen. In some embodiments, the location information 212a, 212b, and 212c can be displayed using different shapes and colors depending on the state of the corresponding robot, and can thus provide a larger amount of information.

The user can monitor the operation mode of the robot and the current location of the robot in real time through the user interface screen 210.

FIG. 2D illustrates monitoring screens related to an individual guide robot 100a.

Referring to FIG. 2D, when the individual guide robot 100a is selected, a user interface screen 220 including history information 221 for a predetermined time period can be provided.

The user interface screen 220 can include current location information of the selected individual guide robot 100a.

The user interface screen 220 can further include notification information 222 about the separate guide robot 100a, such as the remaining capacity of a battery and movement thereof.

Referring to FIG. 2B, the control/service server 11a can include common units 4a and 4b including functions and services that are commonly applied to a plurality of robots and a dedicated unit 4c including specialized functions related to at least some of the plurality of robots.

In some embodiments, the common units 4a and 4b can be classified into basic services 4a and common functions 4b.

The common units 4a and 4b can include a state monitoring service for checking the state of the robots, a diagnostic service for diagnosing the state of the robots, a remote control service for remotely controlling the robots, a robot location tracking service for tracking the location of the robots, a schedule administration service for assigning, checking, and modifying tasks of the robots, a statistics/report service capable of checking various statistical data and analysis reports, and the like.

The common units 4a and 4b can include a user role administration function of administrating the authority of a robot authentication function user, an operation history administrating function, a robot administration function, a firmware administration function, a push function related to push notification, a robot group administration function of setting and administrating groups of robots, a map administrating function of checking and administrating map data and version information, an announcement administrating function, and the like.

The dedicated unit 4c can include specialized functions obtained by considering the places at which the robots are operated, the type of services, and the demands of customers. The dedicated unit 4c can mainly include a specialized function for B2B customers. For example, in the case of the cleaning robot 100d, the dedicated unit 4c can include a cleaning area setting function, a function of monitoring a state for each site, a cleaning reservation setting function, and a cleaning history inquiry function.

The specialized function provided by the dedicated unit 4c can be based on functions and services that are commonly applied. For example, the specialized function can also be configured by modifying the basic services 4a or adding a predetermined service to the basic services 4a. Alternatively, the specialized function can be configured by partially modifying the common function.

In this case, the basic service or the common function corresponding to the specialized function provided by the dedicated unit 4c can be removed or inactivated.

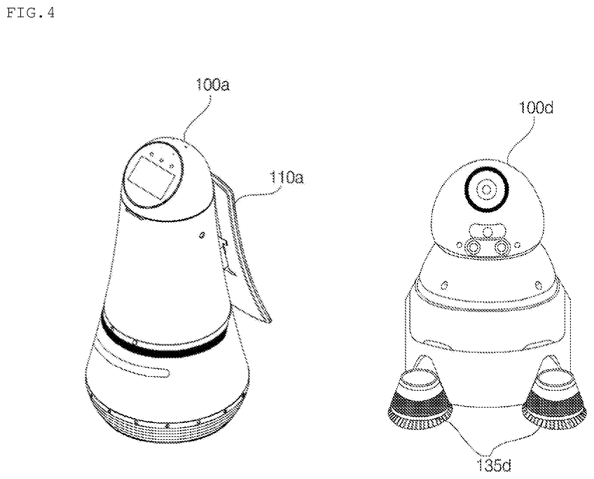

FIG. 3 is a reference view illustrating learning using data acquired by a robot according to an embodiment of the present disclosure.

Referring to FIG. 3, product data acquired through an operation of a predetermined device, such as a robot 100, can be transmitted to the server 10.

For example, the robot 100 can transmit data related to a space, an object, and usage to the server 10.

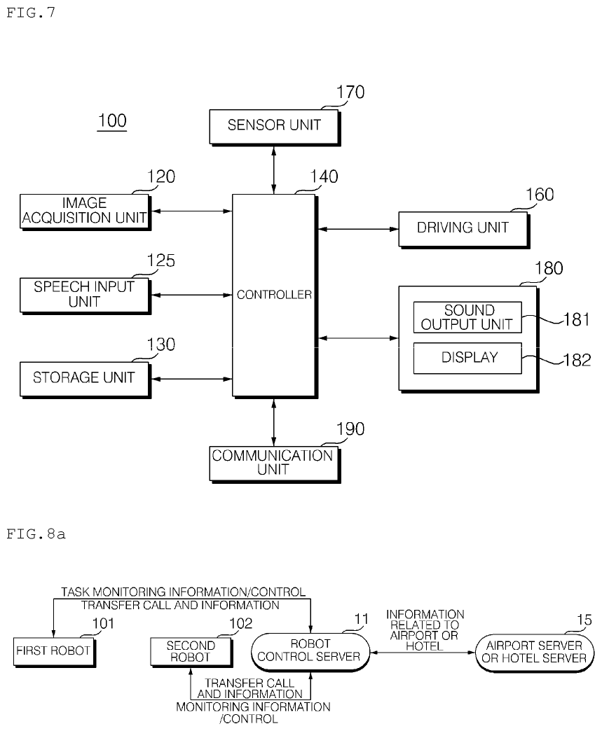

Here, the data related to a space, an object, and usage can be data related to recognition of a space and an object recognized by the robot 100 or can be image data of a space or object acquired by an image acquisition unit 120 (refer to FIG. 7).

In some embodiments, the robot 100 and the server 10 can include a software or hardware type artificial neural network (ANN) trained to recognize at least one of the attributes of a user, the attributes of speech, the attributes of a space, or the attributes of an object, such as an obstacle.

According to an embodiment of the present disclosure, the robot 100 and the server 10 can include a deep neural network (DNN) trained using deep learning, such as a convolutional neural network (CNN), a recurrent neural network (RNN), or a deep belief network (DBN). For example, the deep neural network (DNN), such as the convolutional neural network (CNN), can be installed in a controller 140 (refer to FIG. 7) of the robot 100.

The server 10 can train the deep neural network (DNN) based on the data received from the robot 100 and data input by a user, and can then transmit the updated data of the deep neural network (DNN) to the robot 100. Accordingly, the deep neural network (DNN) pertaining to artificial intelligence included in the robot 100 can be updated.

The usage related data can be data acquired in the course of use of a predetermined product, e.g., the robot 100, can include usage history data and sensing data acquired by a sensor unit 170 (refer to FIG. 7).

The trained deep neural network (DNN) can receive input data for recognition, can recognize the attributes of a person, an object, and a space included in the input data, and can output the result.

The trained deep neural network (DNN) can receive input data for recognition, and can analyze and train usage related data of the robot 100 and can recognize the usage pattern and the usage environment.

The data related to a space, an object, and usage can be transmitted to the server 10 through a communication unit 190 (refer to FIG. 7).

The server 10 can train the deep neural network (DNN) based on the received data, can transmit the updated configuration data of the deep neural network (DNN) to the robot 10, and can then update the data.

Accordingly, a user experience UX in which the robot 100 becomes smarter and evolves along with continual use thereof can be provided.

The robot 100 and the server 10 can also use external information. For example, the server 10 can synthetically use external information acquired from other service servers 20 and 30 associated therewith and can provide an excellent user experience UX.

The server 10 can receive a speech input signal from a user and can perform speech recognition. To this end, the server 10 can include a speech recognition module, and the speech recognition module can include an artificial neural network trained to perform speech recognition on input data and to output the speech recognition result.

In some embodiments, the server 10 can include a speech recognition server for speech recognition. In addition, the speech recognition server can also include a plurality of servers for performing assigned speech recognition procedure. For example, the speech recognition server can include an automatic speech recognition (ASR) server for receiving speech data and converting the received speech data into text data and a natural language processing (NLP) server for receiving the text data from the automatic speech recognition server, analyzing the received text data, and determining a speech command. Depending on the cases, the speech recognition server can further include a text to speech (TTS) server for converting the text speech recognition result output by the natural language processing server into speech data and transmitting the speech data to another server or device.

According to the present disclosure, because the robot 100 and/or the server 10 are capable of performing speech recognition, user speech can be used as input for controlling the robot 100.

According to the present disclosure, the robot 100 can actively provide information or output speech for recommending a function or a service first, and thus more various and active control functions can be provided to the user.

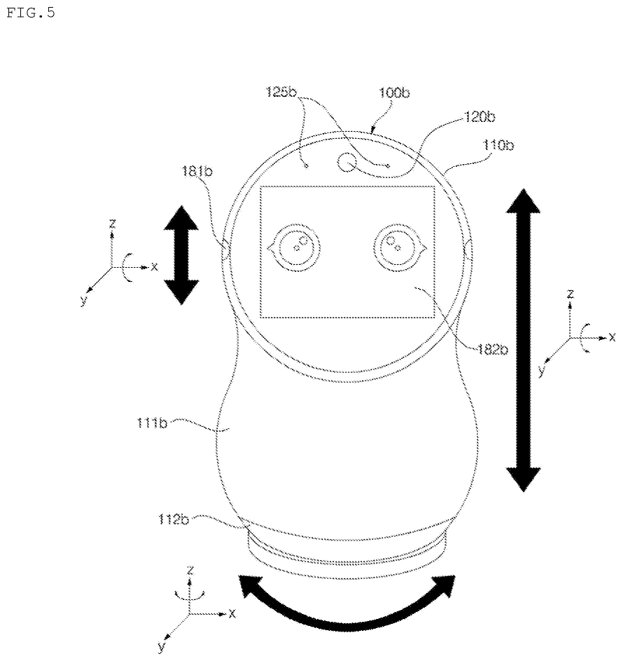

FIGS. 4, 5, and 6A to 6D are diagrams showing examples of robots according to embodiments of the present disclosure. The robots 100 can be disposed or can travel in specific spaces and can perform tasks assigned thereto.

FIG. 4 illustrates an example of mobile robots that are mainly used in a public place. The mobile robot is a robot that autonomously moves using wheels. Accordingly, the mobile robot can be a guide robot, a cleaning robot, a domestic robot, a guard robot. However, the present disclosure is not limited to the type of the mobile robot.

FIG. 4 illustrates an example of a guide robot 100a and a cleaning robot 100d.

The guide robot 100a can include a display 110a and can display a predetermined image, such as a user interface screen.

The guide robot 100a can display a user interface (UI) image including events, advertisements, and guide information on the display 110a. The display 110a can be configured as a touchscreen and can also be used as an input element.

The guide robot 100a can receive user input, such as touch input or speech input, and can display information on an object or a place corresponding to the user input on a screen of the display 110a.

In some embodiments, the guide robot 100a can include a scanner for identifying a ticket, an airline ticket, a barcode, a QR code, and the like for guidance.

The guide robot 100a can provide a guidance service of directly guiding a user to a specific destination while moving to the specific destination in response to a user request.

The cleaning robot 100d can include a cleaning tool 135d, such as a brush, and can clean a specific space while autonomously moving.

The mobile robots 100a and 100d can perform assigned tasks while traveling in specific spaces. The mobile robots 100a and 100d can perform autonomous travel, in which the robots move while generating a path to a specific destination, or following travel, in which the robots follow people or other robots. To prevent a safety-related accident, the mobile robots 100a and 100d can travel while detecting and avoiding an obstacle based on image data acquired by the image acquisition unit 120 or sensing data acquired by the sensor unit 170 while moving.

FIG. 5 is a front view illustrating an outer appearance of a home robot according to an embodiment of the present disclosure.

Referring to FIG. 5, the home robot 100b includes main bodies 111b and 112b forming an outer appearance thereof and accommodating various components.

The main bodies 111b and 112b can include a body 111b forming a space for various components included in the home robot 100b, and a support unit 112b disposed at the lower side of the body 111b for supporting the body 111b.

The home robot 100b can include a head 110b disposed at the upper side of the main bodies 111b and 112b. A display 182 for displaying an image can be disposed on a front surface of the head 110b.

In the specification, the forward direction can be a positive y-axis direction, the upward and downward direction can be a z-axis direction, and the leftward and rightward direction can be an x-axis direction.

The head 110b can be rotated about the x axis within a predetermined angular range.

Accordingly, when viewed from the front, the head 110b can nod in the upward and downward direction in the manner in which a human head nods in the upward and downward direction. For example, the head 110b can perform rotation and return within a predetermined range once or more in the manner in which a human head nods in the upward and downward direction.

In some embodiments, at least a portion of the front surface of the head 100b, on which the display 182 corresponding to the face of the human is disposed, can be configured to nod.

Thus, in the specification, although an embodiment in which the entire head 110b is moved in the upward and downward direction is described, unless particularly otherwise, the operation in which the head 110b nods in the upward and downward direction can be replaced by an operation in which at least a portion of the front surface of the head, on which the display 182 is disposed, nods in the upward and downward direction.

The body 111b can be configured to rotate in the leftward and rightward direction. That is, the body 111b can be configured to rotate at 360 degrees about the z axis.

In some embodiments, the body 111b can also be configured to rotate about the x axis within a predetermined angular range, and thus the body can move in the manner of bowing in the upward and downward direction. In this case, as the body 111b rotates in the upward and downward direction, the head 110b can also rotate about the axis about which the body 111b is rotated.

Thus, in the specification, the operation in which the head 110b nods in the upward and downward direction can include both the case in which the head 110b rotates about a predetermined axis in the upward and downward direction when viewed from the front and the case in which, as the body 111b nods in the upward and downward direction, the head 110b connected to the body 111b also rotates and thus nods.

The home robot 100b can include an image acquisition unit 120b for capturing an image of surroundings of the main bodies 111b and 112b, or an image of at least a predetermined range based on the front of the main bodies 111b and 112b.

The image acquisition unit 120b can capture an image of the surroundings of the main bodies 111b and 112b and an external environment and can include a camera module. A plurality of cameras can be installed at respective positions to improve photographing efficiency. In detail, the image acquisition unit 120b can include a front camera provided at the front surface of the head 110b for capturing an image of the front of the main bodies 111b and 112b.

The home robot 100b can include a speech input unit 125b for receiving user speech input.

The speech input unit 125b can include or can be connected to a processing unit for converting analog sound into digital data and can convert a user input speech signal into data to be recognized by the server 10 or the controller 140.

The speech input unit 125b can include a plurality of microphones for improving the accuracy of reception of user speech input and determining the location of a user.

For example, the speech input unit 125b can include at least two microphones.

The plurality of microphones (MIC) can be spaced apart from each other at different positions and can acquire and convert an external audio signal including a speech signal into an electrical signal.

At least two microphones, that is, input devices, can be required to estimate a sound source from which sound is generated and the orientation of the user, and as the physical distance between the microphones increases, resolution (angle) in detecting the direction increases. In some embodiments, two microphones can be disposed on the head 110b. Two microphones can be further disposed on the rear surface of the head 110b, and thus the location of the user in a three-dimensional space can be determined.

Sound output units 181b can be disposed on the left and right surfaces of the head 110b and can output predetermined information in the form of sound.

The outer appearance and configuration of the robot is exemplified in FIG. 5 and the present disclosure is not limited thereto. For example, the entire robot 110 can tilt or swing in a specific direction, differently from the rotational direction of the robot 100 exemplified in FIG. 5.

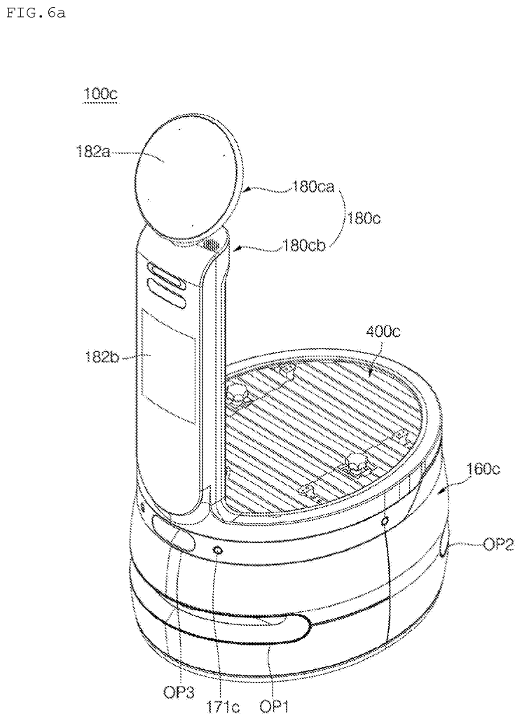

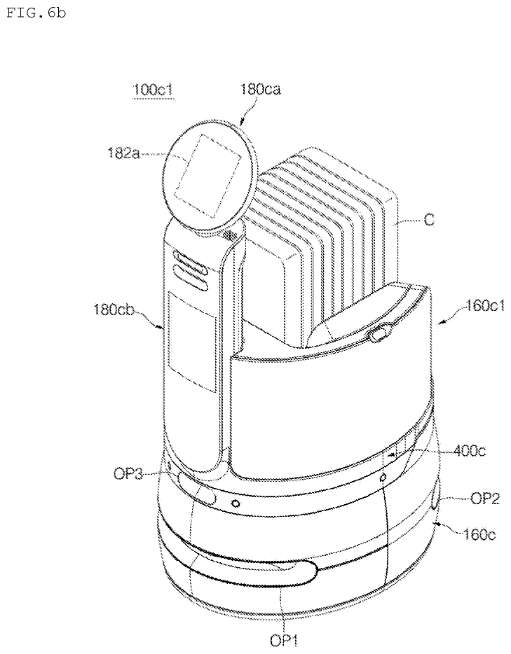

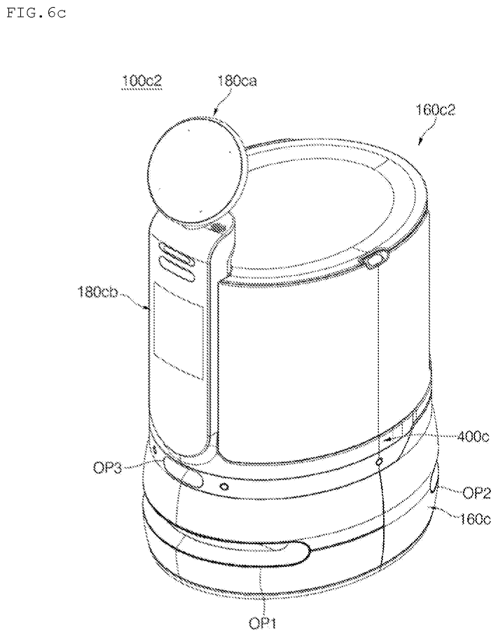

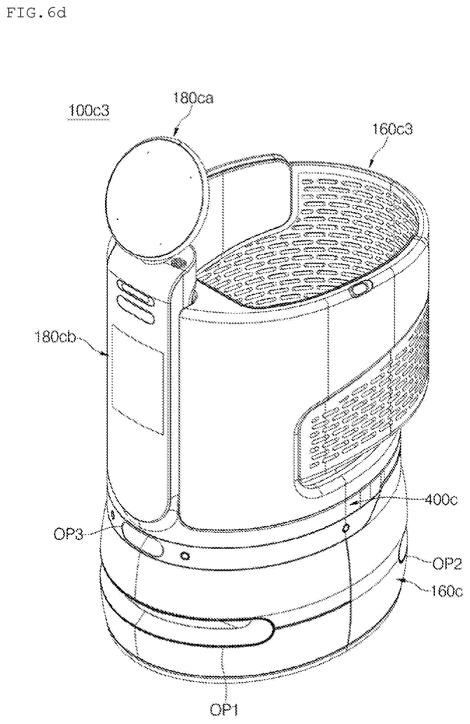

FIGS. 6A to 6D are diagrams showing examples of delivery robots 100c, 100c1, 100c2, and 100c3 for delivering predetermined articles.

Referring to the drawings, the delivery robots 100c, 100c1, 100c2, and 100c3 can travel in an autonomous or following manner, each of the delivery robots can move to a predetermined place while carrying a load, an article, or a baggage C, and depending on the cases, each of the delivery robots can also provide a guidance service of guiding a user to a specific place.

The delivery robots 100c, 100c1, 100c2, and 100c3 can autonomously travel at a specific place and can provide guidance to a specific place or can deliver loads, such as baggage.

The delivery robots 100c, 100c1, 100c2, and 100c3 can follow a user while maintaining a predetermined distance from the user.

In some embodiments, each of the delivery robots 100c, 100c1, 100c2, and 100c3 can include a weight sensor for detecting the weight of a load to be delivered, and can inform the user of the weight of the load detected by the weight sensor.

A modular design can be applied to each of the delivery robots 100c, 100c1, 100c2, and 100c3 and can provide services optimized depending on the use environment and purpose.

For example, the basic platform 100c can include a traveling module 160c, which is in charge of traveling and includes a wheel and a motor, and a UI module 180c, which is in charge of interacting with a user and includes a display, a microphone, and a speaker.

Referring to the drawings, the traveling module 160c can include one or more openings OP1, OP2, and OP3.

The first opening OP1 can be formed in the traveling module 160c to allow a front lidar to be operable, and can be formed over the front to the side of the outer circumferential surface of the traveling module 160c.

The front lidar can be disposed in the traveling module 160c to face the first opening OP1. Accordingly, the front lidar can emit a laser through the first opening OP1.

The second opening OP2 can be formed in the traveling module 160c to allow a rear lidar to be operable, and can be formed over the rear to the side of the outer circumferential surface of the traveling module 160c.

The rear lidar can be disposed in the traveling module 160c to face the second opening OP2. Accordingly, the rear lidar can emit a laser through the second opening OP2.

The third opening OP3 can be formed in the traveling module 160c to allow a sensor disposed in the traveling module, such as a cliff sensor for detecting whether a cliff is present on a floor within a traveling area, to be operable.

A sensor can be disposed on the outer surface of the traveling module 160c. An obstacle sensor, such as an ultrasonic sensor 171c, for detecting an obstacle can be disposed on the outer surface of the traveling module 160c.

For example, the ultrasonic sensor 171c can be a sensor for measuring a distance between an obstacle and each of the delivery robots 100c, 100c1, 100c2, and 100c3 using an ultrasonic signal. The ultrasonic sensor 171c can detect an obstacle adjacent to each of the delivery robots 100c, 100c1, 100c2, and 100c3.

For example, a plurality of ultrasonic sensors 171c can be configured to detect obstacles adjacent to the delivery robots 100c, 100c1, 100c2, and 100c3 in all directions. The ultrasonic sensors 171c can be spaced apart from each other along the circumference of the traveling module 160c.

In some embodiments, the UI module 180c can include two displays 182a and 182b, and at least one of the two displays 182a and 182b can be configured in the form of a touchscreen and can also be used as an input element.

The UI module 180c can further include the camera of the image acquisition unit 120. The camera can be disposed on the front surface of the UI module 180c and can acquire image data of a predetermined range from the front of the UI module 180c.

In some embodiments, at least a portion of the UI module 180c can be configured to rotate. For example, the UI module 180c can include a head unit 180ca configured to rotate in the leftward and rightward direction and a body unit 180cb for supporting the head unit 180ca.

The head unit 180ca can rotate based on an operation mode and a current state of the delivery robots 100c, 100c1, 100c2, and 100c3.

The camera can be disposed at the head unit 180ca and can acquire image data of a predetermined range in a direction in which the head unit 180ca is oriented.

For example, in the following traveling mode in which the delivery robots 100c, 100c1, 100c2, and 100c3 follow a user, the head unit 180ca can rotate to face forwards. In the guide mode in which the delivery robots 100c, 100c1, 100c2, and 100c3 provide a guidance service of guiding a user to a predetermined destination while moving ahead of the user, the head unit 180ca can rotate to face backwards.

The head unit 180ca can rotate to face a user identified by the camera.

The porter robot 100c1 can further include a delivery service module 160c1 for accommodating a load as well as components of the basic platform 100c. In some embodiments, the porter robot 100c1 can include a scanner for identifying a ticket, an airline ticket, a barcode, a QR code, and the like for guidance.

The serving robot 100c2 can further include a serving service module 160c2 for accommodating serving articles as well as the components of the basic platform 100c. For example, serving articles in a hotel can correspond to towels, toothbrushes, toothpaste, bathroom supplies, bedclothes, drinks, foods, room service items, or other small electronic devices. The serving service module 160c2 can include a space for accommodating serving articles and can stably deliver the serving articles. The serving service module 160c2 can include a door for opening and closing the space for accommodating the serving articles, and the door can be manually and/or automatically opened and closed.

The cart robot 100c3 can further include a shopping cart service module 160c3 for accommodating customer shopping articles as well as the components of the basic platform 100c. The shopping cart service module 160c3 can include a scanner for recognizing a barcode, a QR code, and the like of a shopping article.

The service modules 160c1, 160c2, and 160c3 can be mechanically coupled to the traveling module 160c and/or the UI module 180c. The service modules 160c1, 160c2, and 160c3 can be conductively coupled to the traveling module 160c and/or the UI module 180 and can transmit and receive a signal. Accordingly, they can be organically operated.

To this end, the delivery robots 100c, 100c1, 100c2, and 100c3 can include a coupling unit 400c for coupling the traveling module 160c and/or the UI module 180 to the service modules 160c1, 160c2, and 160c3.

FIG. 7 is a schematic internal block diagram illustrating an example of a robot according to an embodiment of the present disclosure.

Referring to FIG. 7, the robot 100 according to the embodiment of the present disclosure can include a controller 140 for controlling an overall operation of the robot 100, a storage unit 130 for storing various data, and a communication unit 190 for transmitting and receiving data to and from another device such as the server 10.

The controller 140 can control the storage unit 130, the communication unit 190, a driving unit 160, a sensor unit 170, and an output unit 180 in the robot 100, and thus can control an overall operation of the robot 100.

The storage unit 130 can store various types of information required to control the robot 100 and can include a volatile or nonvolatile recording medium. The recording medium can store data readable by a microprocessor and can include, for example, a hard disk drive (HDD), a solid state disk (SSD), a silicon disk drive (SDD), a ROM, a RAM, a CD-ROM, a magnetic tape, a floppy disk, and an optical data storage device.

The controller 140 can control the communication unit 190 to transmit the operation state of the robot 100 or user input to the server 10 or the like.

The communication unit 190 can include at least one communication module, can connect the robot 100 to the Internet or to a predetermined network, and can communicate with another device.

The communication unit 190 can be connected to a communication module provided in the server 10 and can process transmission and reception of data between the robot 100 and the server 10.

The robot 100 according to the embodiment of the present disclosure can further include a speech input unit 125 for receiving user speech input through a microphone.

The speech input unit 125 can include or can be connected to a processing unit for converting analog sound into digital data and can convert a user input speech signal into data to be recognized by the server 10 or the controller 140.

The storage unit 130 can store data for speech recognition, and the controller 140 can process the user speech input signal received through the speech input unit 125, and can perform a speech recognition process.

The speech recognition process can be performed by the server 10, not by the robot 100. In this case, the controller 140 can control the communication unit 190 to transmit the user speech input signal to the server 10.

Alternatively, simple speech recognition can be performed by the robot 100, and high-dimensional speech recognition such as natural language processing can be performed by the server 10.

For example, upon receiving speech input including a predetermined keyword, the robot 100 can perform an operation corresponding to the keyword, and other speech input can be performed through the server 10. Alternatively, the robot 100 can merely perform wake word recognition for activating a speech recognition mode, and subsequent speech recognition of the user speech input can be performed through the server 10.

The controller 140 can perform control to enable the robot 100 to perform a predetermined operation based on the speech recognition result.

The robot 100 can include an output unit 180 and can display predetermined information in the form of an image or can output the predetermined information in the form of sound.

The output unit 180 can include a display 182 for displaying information corresponding to user command input, a processing result corresponding to the user command input, an operation mode, an operation state, and an error state in the form of an image. In some embodiments, the robot 100 can include a plurality of displays 182.

In some embodiments, at least some of the displays 182 can configure a layered structure along with a touchpad and can configure a touchscreen. In this case, the display 182 configuring the touchscreen can also be used as an input device for allowing a user to input information via touch as well as an output device.

The output unit 180 can further include a sound output unit 181 for outputting an audio signal. The sound output unit 181 can output an alarm sound, a notification message about the operation mode, the operation state, and the error state, information corresponding to user command input, and a processing result corresponding to the user command input in the form of sound under the control of the controller 140. The sound output unit 181 can convert an electrical signal from the controller 140 into an audio signal, and can output the audio signal. To this end, a speaker can be embodied.

In some embodiments, the robot 100 can further include an image acquisition unit 120 for capturing an image of a predetermined range.

The image acquisition unit 120 can capture an image of a region around the robot 100, an external environment, and the like, and can include a camera module. A plurality of cameras can be installed at predetermined positions for photographing efficiency.

The image acquisition unit 120 can capture an image for user recognition. The controller 140 can determine an external situation or can recognize a user (a guidance target) based on the image captured by the image acquisition unit 120.

When the robot 100 is a mobile robot such as the guide robot 100a, the delivery robots 100c, 100c1, 100c2, and 100c3, and the cleaning robot 100d, the controller 140 can perform control to enable the robot 100 to travel based on the image captured by the image acquisition unit 120.

The image captured by the image acquisition unit 120 can be stored in the storage unit 130.

When the robot 100 is a mobile robot such as the guide robot 100a, the delivery robots 100c, 100c1, 100c2, and 100c3, and the cleaning robot 100d, the robot 100 can further include a driving unit 160 for movement. The driving unit 160 can move a main body under the control of the controller 140.

The driving unit 160 can include at least one driving wheel for moving the main body of the robot 100. The driving unit 160 can include a driving motor connected to the driving wheel for rotating the driving wheel. Respective driving wheels can be installed on left and right sides of the main body and can be referred to as a left wheel and a right wheel.

The left wheel and the right wheel can be driven by a single driving motor, but as necessary, a left wheel driving motor for driving the left wheel and the right wheel driving motor for driving the right wheel can be separately installed. A direction in which the main body travels can be changed to the left or to the right based on a rotational speed difference between the left wheel and the right wheel.

An immobile robot 100 such as the home robot 100b can include a driving unit 160 for performing a predetermined action as described above with reference to FIG. 5.

In this case, the driving unit 160 can include a plurality of driving motors for rotating and/or moving the body 111b and the head 110b.

The robot 100 can include a sensor unit 170 including sensors for detecting various data related to an operation and state of the robot 100.

The sensor unit 170 can further include an operation sensor for detecting an operation of the robot 100 and outputting operation information. For example, a gyro sensor, a wheel sensor, or an acceleration sensor can be used as the operation sensor.

The sensor unit 170 can include an obstacle sensor for detecting an obstacle. The obstacle sensor can include an infrared sensor, an ultrasonic sensor, an RF sensor, a geomagnetic sensor, a position sensitive device (PSD) sensor, a cliff sensor for sensing whether a cliff is present on a floor within a traveling area, and a light detection and ranging (lidar).

The obstacle sensor senses an object, particularly an obstacle, present in the direction in which the mobile robot 100 travels (moves), and transfers information on the obstacle to the controller 140. In this case, the controller 140 can control the motion of the robot 100 depending on the position of the detected obstacle.

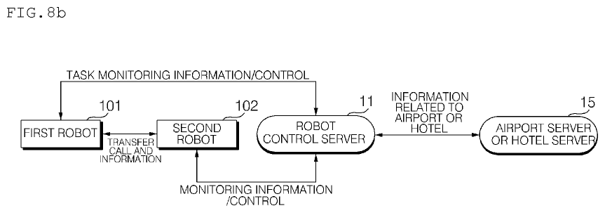

FIG. 8A is a reference diagram illustrating a system for cooperation between robots via a server according to an embodiment of the present disclosure.

Referring to FIG. 8A, a first robot 101 and a second robot 102 can communicate with the control server 11.

The first robot 101 and the second robot 102 can transmit various types of information such as user requests and state information to the control server 11.

The control server 11 can control the first robot 101 and the second robot 102, can monitor the state of the first robot 101 and the second robot 102, and can monitor the storage of the first robot 101 and the second robot 102 and a current state of tasks assigned to the first robot 101 and the second robot 102.

The first robot 101 can receive user input for requesting a predetermined service. The first robot 101 can call another robot, can make a request to the called robot for task support, and can transmit information related to the user requests to the control server 11.

The control server 11 can check the current state information of robots and can identify a support robot for supporting the task requested by the first robot 101.

For example, the control server 11 can select the support robot among the plurality of robots based on at least one of whether the plurality of robots currently perform tasks, the distances between the robots and the first robot 101, or a time at which the robot is expected to finish the current task.

When the second robot 101 is selected as the support robot, the control server 11 can call the second robot 102, can make a request to the called second robot 102 for task support, and can transmit information related to the user requests to the second robot 102. The task support in response to the call of the first robot 101 can correspond to a duty of the second robot 102.

The control server 11 can monitor and control an operation of the second robot 102 that performs the duty.

Depending on the cases, the control server 11 can transmit information indicating that the second robot 102 supports the task to the first robot 101.

The control server 11 can transmit and receive information to and from a server 15 of a product or service provider such as a big-box store, a shopping mall, and an airport. In this case, the control server 11 can receive information related to the big-box store, the shopping mall, and the airport from the server 15 of the product or service provider such as the big-box store, the shopping mall, and the airport, and can transfer information required to perform the task to the first robot 101 and/or the second robot 102.

For example, the server 15 of the big-box store can provide a product, service related information, event information, environment information, and customer information.

FIG. 8B is a reference view illustrating a system for cooperation between robots according to an embodiment of the present disclosure.

Referring to FIG. 8B, the first robot 101 can receive user input for requesting a predetermined service. The first robot 101 can directly call another robot and can make a request for task support based on the service requested by the user.

The first robot 101 can check the current state information of robots, and can identify a support robot for supporting the task. For example, the first robot 101 can select the support robot among the plurality of robots based on at least one of whether the robots currently perform tasks, the distances between the robots and the first robot 101, or a time at which the robots are expected to finish the current tasks.

To this end, the first robot 101 can receive state information of the robots from the control server 11.

Alternatively, the first robot 101 can transmit a signal for requesting the task support to other robots, and can select the support robot among the robots that transmit a response signal.

In this case, the signal transmitted by the first robot 101 can include information on the location of the first robot 101 or the place at which the service is provided and user requests. The response signal transmitted by the robots can include location information and state information of the robot.

The first robot 101 can check the information included in the response signal and can select the support robot based on a predetermined reference. According to the present embodiment, cooperation can be advantageously provided even if an error occurs in the server 10 or if communication between the server 10 and the first robot 101 is poor.

When the second robot 102 is selected as the support robot, the first robot 101 can call the second robot 102, make a request for task support, and transmit information related to the user requests to the second robot 102. The task support in response to the call of the first robot 101 can be a duty of the second robot 102.

According to the present embodiment, the first robot 101 and the second robot 102 can also communicate with the control server 11.

The first robot 101 and the second robot 102 can transmit various types of information such as state information to the control server 11, and the control server 11 can monitor and control the state of the first robot 101 and the second robot 102 and a current state of tasks assigned to the first robot 101 and the second robot 102.

In this case, the control server 11 can also transmit and receive information to and from a server 15 of a product or service provider such as a big-box store, a shopping mall, and an airport. For example, the control server 11 can receive information related to the big-box store, the shopping mall, and the airport from the server 15 of the product or service provider such as the big-box store, the shopping mall, and the airport, and can transfer information required to perform the task to the first robot 101 and/or the second robot 102.

The control server 11 can be an RSDP 10 according to an embodiment of the present disclosure or can be one of the servers included in the RSDP 10. Accordingly, the operation of the control server 11 described above with reference to FIGS. 8A and 8B can be performed by the RSDP 10. As described above, the RSDP 10 can be configured as a plurality of servers, to which information and functions are distributed, or as a single integrated server.

In FIGS. 8A and 8B, the first robot 101 and the second robot 102 that cooperate with each other can be the same type. Alternatively, the first robot 101 and the second robot 102 can be different types. For example, the first robot 101 can be the guide robot 100a or the home robot 100b that outputs predetermined information in the form of an image and speech and interacts with a user, and the second robot 102 can be one of the delivery robots 100c1, 100c2, and 100c3 such as the serving robot 100c2 for delivering a predetermined article.

A robot can have varying hardware performances and can provide different services depending on the type thereof. Different types of robots can be combined to cooperate with each other, and thus more various and abundant services can be provided.

According to the present disclosure, cooperation between robots can be achieved at an airport or a hotel, and intervention of an administrator can be minimized when the cooperative task is performed, and thus administration cost and time can be reduced, thereby improving use convenience.

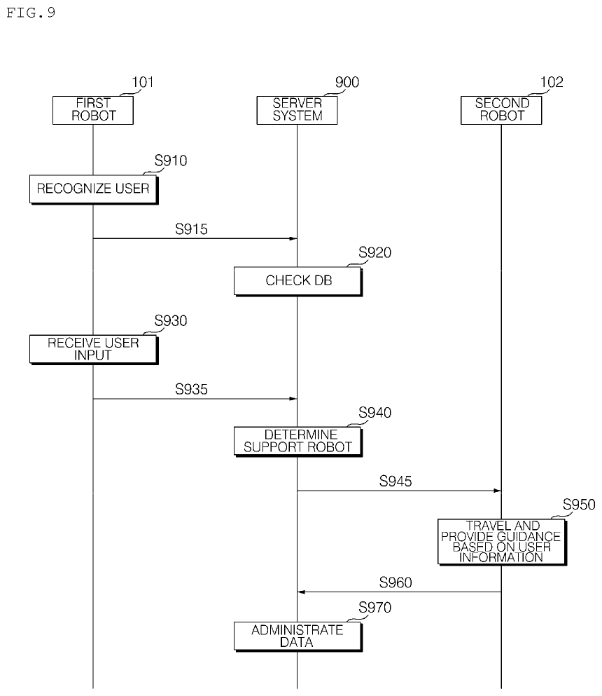

FIG. 9 is a flowchart illustrating a method of controlling a robot system according to an embodiment of the present disclosure.

Referring to FIG. 9, the first robot 101 can recognize identification information of a user (S910).

For example, the first robot 101 can include a scanner for identifying a barcode, a QR code, and the like, can recognize a barcode and a QR code included in a card present by a user, a screen of an electronic device, or the like, and can compare the recognize information with a pre-stored customer database to recognize the user.

When the first robot 101 does not include a customer database due to a problem in terms of a security policy, a data usage amount, or system resource limitations, the first robot 101 can recognize a barcode and a QR code and can transmit the recognized identification information to a server system 900 including one or more servers (S915).

The server system 900 can check user information corresponding to the user identification information in a database (S920).

In some embodiments, the server system 900 can include the first server 10 for controlling a robot and the second server 15 for administrating the user information.

In this case, when the first server 10 checks the user information corresponding to the user identification information in the database and transfers the user information to the second server 15, the second server 15 can determine the support robot and can transfer previous information of the user to the second robot 102, thereby efficiently distributing tasks between servers.

The server system 900 can compare the received identification information with the customer database to recognize a user (S920). In some embodiments, the server system 900 can transmit the user recognition result to the first robot 101.

Alternatively, the first robot 101 can acquire an image of the face of the user, oriented forward, through the image acquisition unit 120 and can compare the acquired image of the face of the user with the pre-stored customer database to recognize the user.

In an embodiment in which the user is recognized based on the image, image data of the face of the user acquired by the first robot 101 can also be transmitted to the server system 900 (S915).

The server system 900 can compare the received image of the face of the user with information stored in the customer database to recognize the user (S920). In some embodiments, the server system 900 can transmit the user recognition result to the first robot 101.

The first robot 101 can receive user input including a predetermined service request (S930). For example, the first robot 101 can receive the user input including a shopping cart service request from the user (S930). Here, the shopping cart service request can be a request for the delivery robots 100c1, 100c2, and 100c3 to carry and deliver a shopping article while a user shops.

The first robot 101 can transmit information based on the user input to the server system 900 (S935).

Here, the information based on the user input can include information on the location of the first robot 101 or the place at which the service is provided and user requests. For example, when a user makes a request for a shopping cart service, the first robot 101 can transmit information on the current location of the first robot 101, a shopping cart service request, and the like to the server system 900.

In some embodiments, the user identification information recognition S910 and the recognized identification information transmission S915 can be performed after the user input reception S930 and the information transmission based on the user input S935.

Alternatively, the user identification information recognition S910 and the recognized identification information transmission S915 can be performed along with the user input reception S930 and the information transmission based on the user input S935.

The server system 900 can identify a support robot for supporting tasks corresponding to the service request (S940).

The server system 900 can select the support robot among a plurality of robots included in the robot system based on at least one of whether the robots currently perform tasks, the distances between the robots and the first robot 101, or a time at which the robots are expected to finish the current tasks.

For example, the server system 900 can select a robot that has finished the task and stands by as the support robot. When a plurality of robots stands by, the server system 900 can select a robot that is the closest to the first robot 101 among the robots that stand by as the support robot.

When all of the robots currently perform tasks, the server system 900 can select the robot expected to finish its task the earliest as the support robot.

When a robot on standby is far away and the sum of the time at which a robot that is performing a task is expected to finish the task and the time taken for the robot that is performing the task to move to the place at which the first robot 101 is located or to a waiting area is less than the time taken for the robot on standby to move to the place at which the first robot 101 is located or the waiting area, the robot that is performing the task can be selected as the support robot.

According to the present disclosure, a support robot suitable for performing a task corresponding to the service requested by the user can be selected and a robot can be efficiently administrated.

The server system 900 can determine the second robot 102 as the support robot according to the aforementioned reference (S940). The first robot 101 and the second robot 102 can be the same type. Alternatively, the first robot 101 and the second robot 102 can be different types. For example, the first robot 101 can be the guide robot 100a for providing guidance for shopping information to a user, and the second robot 102 can be the delivery robots 100c1, 100c2, and 100c3 for moving while carrying a shopping article of the user.

The second robot 102 can be the cart robot 100c3 for supporting a payment service of the user among the delivery robots 100c1, 100c2, and 100c3.

The cart robot 100c3 can be capable of autonomously traveling and following and can support a guidance service, a delivery service, a transportation service, a payment service, or the like.

The server system 900 can make a request to the second robot 102 identified to be the support robot for a predetermined task (S945).

In this case, a signal that is transmitted while the server system 900 makes a request to the second robot 102 to perform a support task can include information on the support task. For example, information transmitted to the second robot 102 can include a location of the first robot 101, a waiting area of a specific customer, a location in which a service is provided, information on user requests, surrounding environment information, and the like.

Then, the second robot 102 can perform the task (S950). For example, the second robot 102 can follow the user and can carry a shopping article of the user. Thus, use convenience of the shopping customer can be improved.

In more detail, in the task request operation (S945), the server system 900 can transfer previous shopping information of the user to the second robot 102, and in the task performing operation S950, the second robot 102 can move based on the previous shopping information of the user.

At least one of a place at which the second robot 102 meets the user or a place to which the second robot 102 guides the user and moves first can be determined based on the previous shopping information of the user.

For example, in the case of a user who has purchased milk, eggs, or the like before, the second robot 102 can stand by for the user at a corner at which a product such as milk, eggs, or the like is displayed, based on a product purchase time point or a product purchase period, or can start shopping from the corner at which a product such as milk, eggs, or the like is displayed, based on the product purchase period.

The second robot 102 can propose a recommended path determined based on the previous shopping information of the user and can support user shopping while moving along the recommended path when the user accepts the recommended path.

While moving, the second robot 102 can output a guidance message at a specific product corner based on the previous shopping information of the user.

For example, the second robot 102 can output a guidance message for providing guidance for a corresponding product to a user who has purchased milk, eggs, or the like before at a corner at which related products are displayed.

In some embodiments, the second robot 102 can stand by in the same area as the first robot 101. In this case, the second robot 102 can immediately perform task support.

However, the second robot 102 can guide people to service usage, can perform other tasks, or can return to a waiting position while autonomously traveling.

As such, when the second robot 102 needs to be moved to start a service, the second robot 102 can move to a calling place included in the support task.

Here, the calling place can be a current position of the first robot 101 or can be a specific place selected based on user information such as previous shopping information of a corresponding user.

The calling place that is not the current position of the first robot 101 can be a place to which the second robot 102 moves and stands by for the recognized user.

When the second robot 102 stands by at a specific waiting place for a specific user, the first robot 101 can output a guidance message for providing guidance for the waiting place of the second robot 102. For example, upon selecting the milk corner as the waiting place, the first robot 101 can provide guidance for information indicating that the second robot 102 waits for a user at the milk corner in the form of an image and/or speech through the output unit 180.

When the second robot 102 stands by at the waiting place for a task for supporting shopping of the user, if there is predetermined input by another person, a guidance message indicating the current waiting state can be output.

Upon receiving a request for the support task for supporting shopping of a specific user (S945), the task of the second robot 102 can be considered to begin, and thus the second robot 102 may not respond to other requests.

In this case, the request of the other person who intends to use the second robot 102, which moves or stands by, can be rejected, in which case people can complain about the request rejection when they do not know the current state of the second robot 102.

Thus, a person who attempts an interaction or a service request can receive guidance for information indicating that the second robot 102 waits for another user, and thus the corresponding service robot and robot performance can be promoted and many people can be satisfied.

The second robot 102 that stands by for the support task needs to identify a user that makes a request for an assigned support task.

To this end, in the task request operation S945, the server system 900 can further transmit identification image information for identifying the user to the second robot 102. The identification image information can be image data that is photographed by the first robot 101 and is transmitted to the server system 900 or image data that is registered in the server system 900 by the user.

For example, the second robot 102 can receive user face image data from the server system 900 and can stand by to determine a face that matches the received face image data from an image acquired through the image acquisition unit 120.

Upon determining that the face matches the received face image data from the image acquired through the image acquisition unit 120, the second robot 102 can output the guidance message towards the corresponding user and can support shopping of the corresponding user.

That is, according to an embodiment of the present disclosure, upon detecting user approaching while standing by at a predetermined position, the second robot 102 can provide shopping assistance while following the user. Accordingly, use convenience of the shopping customer can be improved.

When shopping is finished, the second robot 102 can report task completion to the server system 900 (S960). The task completion report can include information on whether the task has been successfully performed, the details of the task, and the time taken to perform the task.

The server system 900 that receives the task completion report can update data corresponding to the first robot 101 and the second robot 102 based on the task completion report, and can administrate the data (S970). For example, the number of times that the first robot 101 and the second robot 102 perform the task can be increased, and information on the details of the task, such as the type of the task and the time taken to perform the task, can be updated. Accordingly, data related to the robots can be effectively administrated, and the server system 900 can analyze and learn the data related to the robots.

In some embodiments, the confirmation of shopping completion can be automatically performed using the recognition element provided at the second robot 102, such as the weight sensor or the camera.

Alternatively, when touch input, speech input, or another predetermined manipulation is performed by the customer, the second robot 102 can determine that shopping is completed.

When the customer notifies the server system 900 of shopping completion using an electronic device, the server system 900 can notify the second robot 102 and/or the first robot 101 of shopping completion.

The second robot 102 that completes the task can autonomously travel and can return to a predetermined location according to settings.

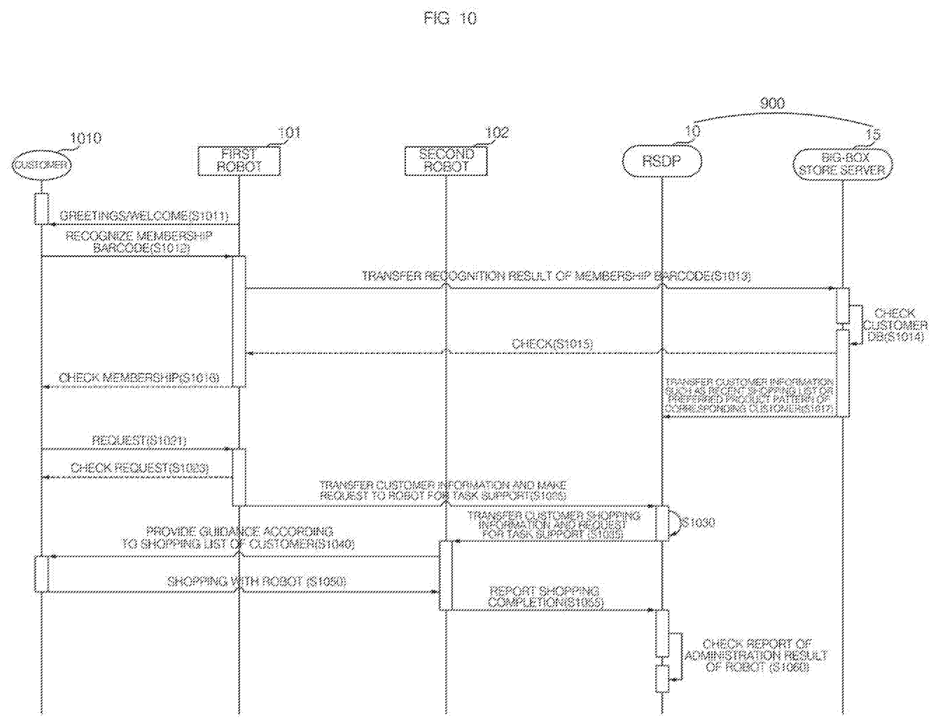

FIG. 10 is a flowchart showing the case in which shopping in a big-box store is supported according to an embodiment of the present disclosure.

Referring to FIG. 10, upon determining that a customer 1010 approaches within a predetermined range based on an image acquired through the image acquisition unit 120, the first robot 101 can output a greeting message for welcoming the customer 1010 in the form of an image and/or speech (S1011).

The customer 1010 can input big-box store membership identification information through the display 182 of the first robot 101 or can execute a big-box store application through a membership card or an electronic device thereof and can then make the first robot 101 recognize the membership barcode (S1012).

The first robot 101 can transmit the membership barcode recognition result to the server system 900 (S1013). For example, the first robot 101 can transmit the membership barcode recognition result to the big-box store server 15 that administrates user information (S1013).

The server system 900 can check the customer database and can check user information including previous shopping information or the like of the user, which corresponds to the membership barcode recognition result (S1015). For example, the big-box store server 15 can check the customer database (S1015).

The big-box store server 15 can notify the first robot 101 of user checking (S1015) and can transmit customer information such as a recent shopping list, a preferred product, or a shopping pattern of the corresponding customer to the RSDP 10 for controlling the robots 101 and 102 (S1017).

The big-box store server 15 can transmit minimum information such as a name, an ID, or the like to the first robot 101 to output welcome greetings. Alternatively, the big-box store server 15 can also transmit at least some of the previous shopping information of the corresponding user to the first robot 101.

The first robot 101 can indicate membership checking (S1016) and can receive a cart service request of the user (S1021).

The first robot 101 that receives the cart service request of the customer 1010 can transfer customer requests to the server system 900 and can make a request for supporting of the shopping cart service task (S1025).

According to settings, the first robot 101 can receive confirmation about the shopping cart service request from the customer 1010 (S1023).

The RSDP 10 can determine the support robot for supporting the shopping cart service task requested by the first robot 101 according to a predetermined reference (S1030).

When the second robot 102 is selected as the support robot, the RSDP 10 can transfer the customer requests to the second robot 102 and can make a request for the shopping cart service task (S1035).

Accordingly, the second robot 102 can perform the shopping cart service task for supporting shopping of the customer 1010 (S1040). In this case, the RSDP 10 can transfer customer shopping information to the second robot 102 (S1025), and the second robot 102 can provide guidance for shopping according to a shopping list of the customer (S1040).

When shopping of the customer 1010 is finished (S1050), the second robot 102 can report task completion to the RSDP 10 (S1055).

The RSDP 10 can check the operation result report of the first robot 101 and the second robot 102 and can store and administrate data (S1060).

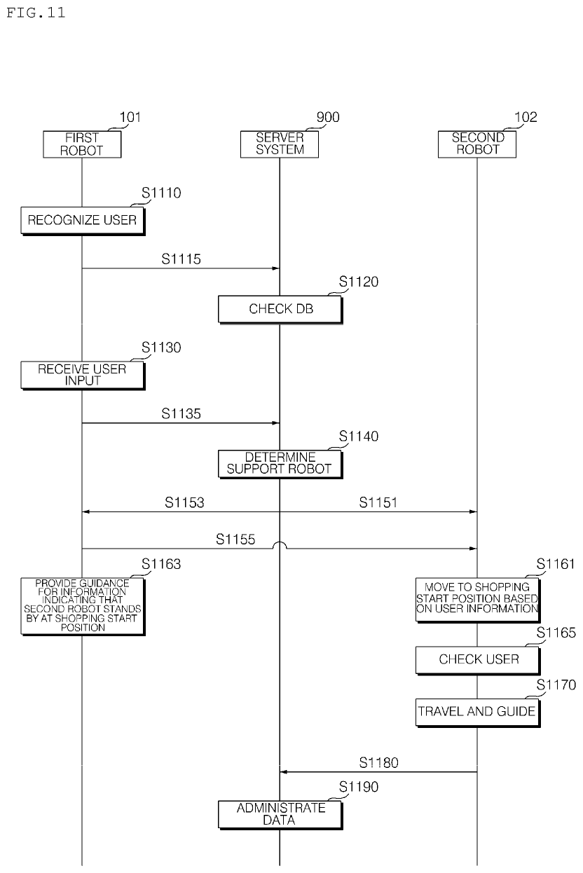

FIG. 11 is a flowchart showing a method of controlling a robot system according to an embodiment of the present disclosure.

Referring to FIG. 11, the first robot 101 can recognize identification information of a user (S1110). For example, the first robot 101 can acquire and recognize membership information such as a barcode or a QR code or user face information.

When the membership information, the user face information, or the like is recognized in a recognizable level, the first robot 101 can transmit the user identification information to the server system 900 (S1115), and the server system 900 can check user information corresponding to the user identification information from a database (S1120).

The first robot 101 can receive user input including a shopping cart service request from the user (S1130) and can transmit information based on the user input to the server system 900 (S1135). Here, the information based on the user input can include information on the position of the first robot 101, a position at which a service is to be provided, or user requests.

The server system 900 can determine the support robot for supporting the task corresponding to the service request (S1140).

The server system 900 can select the support robot among a plurality of robots included in the robot system based on at least one of whether the robots currently perform tasks, the distances between the robots and the first robot 101, or a time at which the robot is expected to finish the current task.

In some embodiments, the server system 900 can determine a waiting place at which the second robot 102 meets the user based on the previous shopping information of the user.

In this case, the server system 900 can make a request to the second robot 102, identified to be the support robot for the predetermined task (S1151).

In this case, the signal that is transmitted while the server system 900 makes a request to the second robot 102 can include information on the support task. For example, the signal transmitted to the second robot 102 by the server system 900 can include a place for waiting for a specific customer, information on user requests, surrounding environment information, and the like.

The server system 900 can notify the first robot 101 of information indicating that the second robot 102 stands by at a waiting place selected as a shopping start position based on the previous shopping information of the user (S1153).

The first robot 101 can provide guidance for information indicating that the second robot 102 stands by at the shopping start position in the form of an image and/or speech (S1163).

In some embodiments, an image captured by photographing the user by the first robot 101 can also be transmitted directly to the second robot 102 (S1155).

Alternatively, the image captured by photographing the user by the first robot 101 can be transmitted to the server system 900, and the server system 900 can transmit identification image information for user identification to the second robot 102.

The identification image information can be image data that is obtained through photograph by the first robot 101 and is transmitted to the server system 900 or image data that is registered in the server system 900 by the user.

The second robot 102 can move to the shopping start position selected based on the user information and can then standby (S1161).

When the second robot 102 stands by at the selected shopping start position (S1161) and then checks user access (S1165), the second robot 102 can provide shopping assistance while following the user (S1170).

The second robot 102 can also output the guidance message for providing guidance for shopping information at a specific corner or position while moving along with the verified user (S1170). Accordingly, use convenience of the shopping customer can be improved.

When shopping is finished, the second robot 102 can report task completion to the server system 900 (S1180). The server system 900 can update data corresponding to the first robot 101 and the second robot 102 based on the task completion report and can administrate the data (S1190).

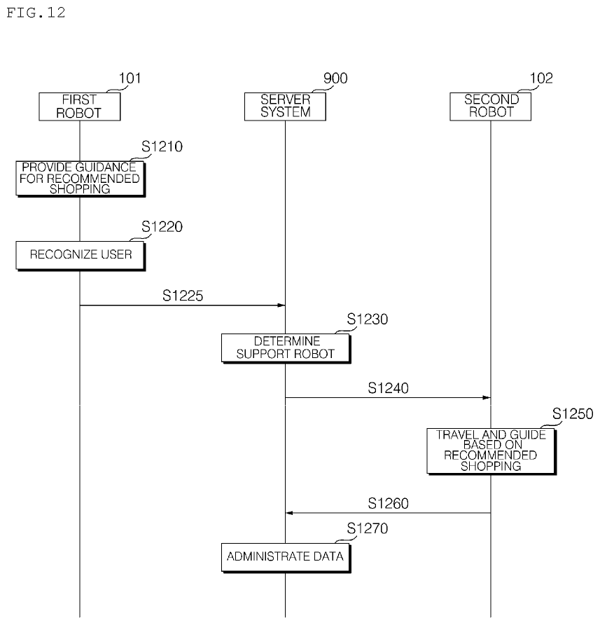

FIG. 12 is a flowchart showing a method of controlling a robot system according to an embodiment of the present disclosure.

Referring to FIG. 12, the first robot 101 can output a guidance message for providing guidance for recommended shopping information such as an event, a place at which the event occurs, or a recommended path (S1210).

For example, the first robot 101 can output a guidance message for providing guidance for a specific product or an event in the form of an image and/or speech to a user who is detected to perform access or a user who currently interacts therewith (S1210).

Upon receiving user input for making a request for a service based on recommended shopping information from the user (S1220), the first robot 101 can transmit information based on the user input to the server system 900 (S1225).

That is, when the user approves a shopping service based on the recommended shopping information (S1220), the first robot 101 can transfer the recommended shopping information and the user requests to the server system 900 and can make a request for the shopping service based on the recommended shopping information (S1225).

The server system 900 can determine a support robot for supporting a task corresponding to the service request (S1230).

The server system 900 can select the support robot among the plurality of robots included in the robot based on at least one of whether the plurality of robots currently perform tasks, the distances between the robots and the first robot 101, or a time at which the robot is expected to finish the current task.

The first robot 101 and the second robot 102 can be the same type. Alternatively, the first robot 101 and the second robot 102 can be different types. For example, the first robot 101 can be the guide robot 100a for providing guidance for shopping information to the user, and the second robot 102 can be the delivery robots 100c1, 100c2, and 100c3 that move while carrying shopping articles of the user.

The server system 900 can make a request to the second robot 102 identified to be the support robot for a shopping service support task based on the recommended shopping information (S1240).

In this case, the signal that is transmitted while the server system 900 makes a request to the second robot 102 for a support task can include information on the support task. For example, the signal transmitted to the second robot 102 can include a waiting place based on a location of the first robot 101 or the recommended shopping information, information on user requests, surrounding environment information, and the like.

Then, the second robot 102 can perform the shopping service support task based on the recommended shopping information (S1250). The second robot 102 can provide shopping assistance to the customer while moving based on the recommended shopping information (S1250). In addition, the second robot 102 can provide guidance for a predetermined event or a predetermined product while moving along the recommended path based on the recommended shopping information.

According to the present embodiment, a specific event and a product can be promoted irrespective of a customer history and guidance for movement to a specific place can be provided, thereby improving sales.

In some embodiments, the second robot 102 can stand by in the same area as the first robot 101. In this case, the second robot 102 can immediately perform the support task.

However, when the second robot 102 needs to be moved to start a service, the second robot 102 can move to a calling place included in the support task.

Here, the calling place can be a current position of the first robot 101 or can be a waiting place based on the recommended shopping information.

The calling place, which is not the current position of the first robot 101, can be a place to which the second robot 102 moves and stands by for the recognized user.

When the second robot 102 stands by at a specific place for waiting for a specific user, the first robot 101 can output a guidance message for guidance to the waiting place of the second robot 102. For example, upon selecting the milk corner as the waiting place based on the recommended shopping information, the first robot 101 can provide guidance for information indicating that the second robot 102 waits for a user at the milk corner in the form of an image and/or speech through the output unit 180.

When the second robot 102 stands by at the waiting place for a task for supporting shopping of the user based on the recommended shopping information, if there is predetermined input by another person, a guidance message indicating the current waiting state can be output.

The second robot 102 can provide guidance for information indicating that the second robot 102 waits for another user to a person who attempts an interaction or makes a service request other than a user who approves the recommended shopping information, and thus the corresponding service robot and robot performance can be promoted and many people can be satisfied.

The second robot 102 that stands by for the shopping service support task based on the recommended shopping information needs to identify a user that makes a request for an assigned support task.

To this end, in the task request operation S1240, the server system 900 can further transmit identification image information for identifying the user to the second robot 102. The identification image information can be image data that is photographed by the first robot 101 and is transmitted to the server system or image data that is registered in the server system 900 by the user.

For example, the second robot 102 can receive user face image data from the server system 900 and can stand by to determine a face that matches the received face image data from an image acquired through the image acquisition unit 120.

Upon determining that the face that matches the received face image data from the image acquired through the image acquisition unit 120, the second robot 102 can output the guidance message towards the corresponding user and can support shopping by the corresponding user.

That is, according to an embodiment of the present disclosure, upon detecting user approaching while standing by at a predetermined position, the second robot 102 can provide assistance while following the user. Accordingly, use convenience of the shopping customer can be improved.

When shopping is finished, the second robot 102 can report task completion to the server system 900 (S1260). The server system 900 can update data corresponding to the first robot 101 and the second robot 102 based on the task completion report and can administrate the data (S1270).

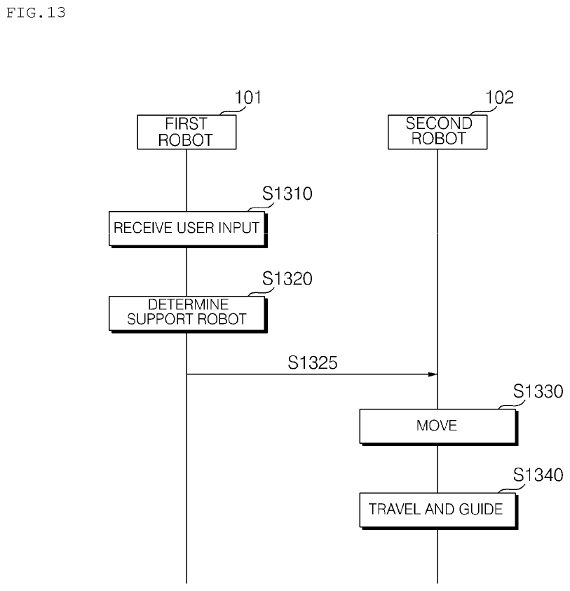

FIG. 13 is a flowchart showing a method of controlling a robot system according to an embodiment of the present disclosure.

Referring to FIG. 13, the first robot 101 can receive user input including a shopping cart service request from a user (S1310) and can determine the support robot for supporting the task corresponding to the service request (S1320).

The first robot 101 can select the support robot among the plurality of robots included in the robot based on at least one of whether the plurality of robots currently perform tasks, the distances between the robots and the first robot 101, or a time at which the robot is expected to finish the current task.

The first robot 101 can determine the second robot 102 as the support robot according to the aforementioned reference (S1320). The first robot 101 and the second robot 102 can be the same type. Alternatively, the first robot 101 and the second robot 102 can be different types. For example, the first robot 101 can be the guide robot 100a for providing guidance for shopping information to the user, and the second robot 102 can be the delivery robots 100c1, 100c2, and 100c3 that move while carrying shopping articles of the user.

The first robot 101 can previously download recommended shopping information related to a predetermined product and an event. In this case, as described above with reference to FIG. 12, the first robot 101 can output the recommended shopping information and can make a request to the second robot 102 for task support for a user who makes a request for the shopping service based on the recommended shopping information.

In some embodiments, the first robot 101 can access the user database for checking user information in response to the user input, can check the user information, and can provide a customer customized service.

Even in the present embodiment, as described above with reference to FIGS. 9 to 13, the second robot 102 can move to the calling place (S1330) and can then provide guidance for shopping while traveling based on the user information or the recommended shopping information from the calling place (S1340).

That is, the first robot 101 can call the second robot 102 and can transmit the recommended shopping information or user information such as a user purchase history or a path to the second robot 102, and the second robot 102 can assist user shopping according to the recommended shopping information or the user information.

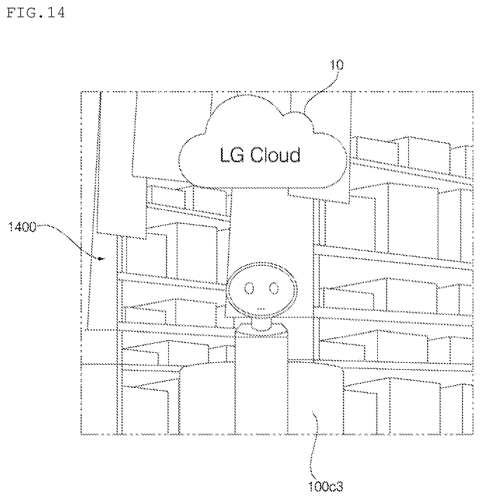

FIGS. 14 to 17 are reference diagrams for explanation of an operation of a robot system according to an embodiment of the present disclosure.

Referring to FIG. 14, the cart robot 100c3 according to an embodiment of the present disclosure can download information on a display location and an event, and promotion information in a big-box store 1400 from the server system 900 such as the RSDP 10.

The cart robot 100c3 can receive a request for a task for supporting shopping of a predetermined customer from the server system 900 such as the RSDP 10.

The cart robot 100c3 that receives the request of the server system 900 such as the RSDP 10 can move to a predetermined calling place and can support shopping of the user. In some embodiments, the cart robot 100c3 can support shopping based on the previous shopping information of the user or shopping based on the recommended shopping information.

The cart robot 100c3, to which a task is not assigned, can provide guidance for service use while autonomously traveling to a service place such as a big-box store. For example, when the customer makes a request to the cart robot 100c3 for a service or following traveling mode activation through speech recognition or display touch, the cart robot 100c3 can support shopping while tracking the customer in the following traveling mode.

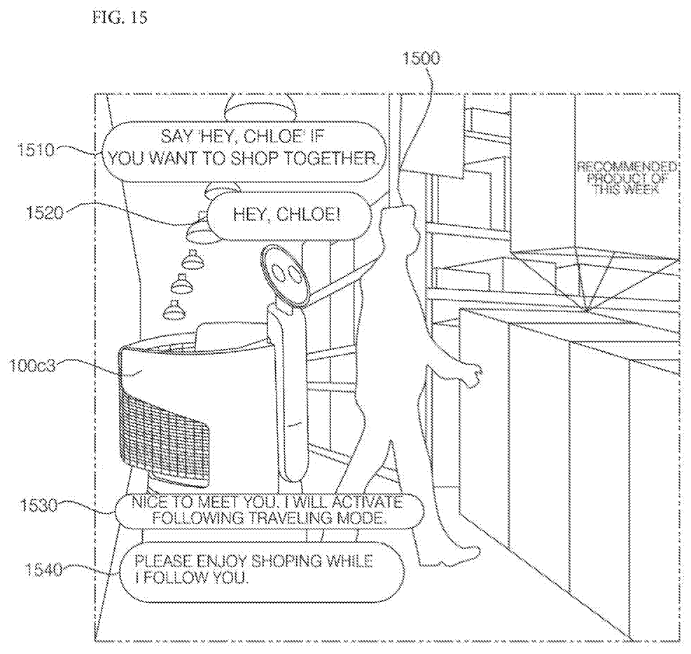

Referring to FIG. 15, the cart robot 100c3 that autonomously travels can output a speech guidance message 1510 for providing guidance for a method of using a service or a calling expression such as “Say ‘Hey, Chloe’ if you want to shop together.” through the sound output unit 181.

When a customer 1500 utters speech including the calling expression (1520), the cart robot 100c3 can stop and can output speech guidance messages 1530 and 1540 such as “Nice to meet you. I will activate following traveling mode.” or “Please enjoy shopping while I follow you I will follow you.”.

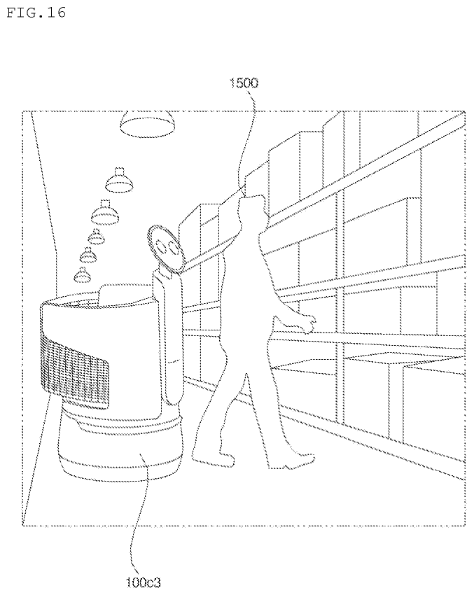

Referring to FIG. 16, the customer 1500 can scan a product using a scanner included in the cart robot 100c3 and can enjoy shopping while putting the product in a service module 160c3 of the cart robot 100c3.

The UI module 180c of the cart robot 100c3 can output an image on which the shopping total is updated in real time along with scanning.

The UI module 180c can provide a user interface for specific product inquiry. When the customer 1500 selects another product inquiry through the provided user interface, the cart robot 100c3 can be guided for the corresponding product location.

When there is user input corresponding to shopping completion or when the cart robot 100c3 arrives at a checkout counter such as autonomous checkout counter, the cart robot 100c3 can assist payment of the customer.

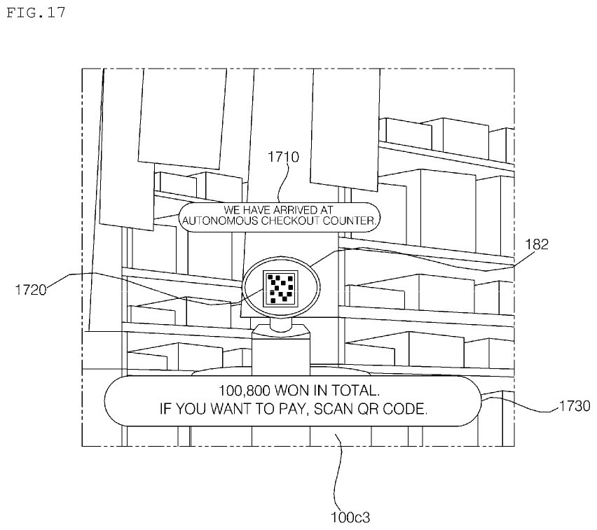

Referring to FIG. 17, the cart robot 100c3 can output the user input or a guidance message 1710 indicating that the cart robot 100c3 arrives at the checkout counter in the form of an image and/or speech, and then a payment image 1720 can be activated on the display 182 of the UI module 180c, and the sound output unit 181 can output a speech guidance message 1730 for providing guidance for payment.

Accordingly, the customer 1500 can enjoy their shopping using the cart robot 100c3 without intervention or impedance of another person and can easily carry and pay for a product.

When shopping is completed, the cart robot 100c3 can report a task performed on the server system 900.

The server system 900 can provide a result report about the number of customers who use the cart robot 100c3, sales through the cart robot 100c3, the number of times that an event/promotion coupon is used, and the like to an administrator.

The robot system according to the present disclosure and the method of controlling the same are not limitedly applied to the constructions and methods of the embodiments as previously described; rather, all or some of the embodiments can be selectively combined to achieve various modifications.

The method of controlling the robot system according to the embodiment of the present disclosure can be implemented as code that can be written on a processor-readable recording medium and thus read by a processor. The processor-readable recording medium can be any type of recording device in which data is stored in a processor-readable manner. The processor-readable recording medium can include, for example, read only memory (ROM), random access memory (RAM), compact disc read only memory (CD-ROM), magnetic tape, a floppy disk, and an optical data storage device, and can be implemented in the form of a carrier wave transmitted over the Internet. In addition, the processor-readable recording medium can be distributed over a plurality of computer systems connected to a network such that processor-readable code is written thereto and executed therefrom in a decentralized manner.

It will be apparent that, although the preferred embodiments have been shown and described above, the present disclosure is not limited to the above-described specific embodiments, and various modifications and variations can be made by those skilled in the art without departing from the gist of the appended claims. Thus, it is intended that the modifications and variations should not be understood independently of the technical spirit or prospect of the present disclosure.

1. A method of controlling a robot system, the method comprising:
recognizing identification information of a first user, by a first robot;
transmitting a recognition result of the identification information of the first user to a server system, by the first robot;
receiving user input including a service request from the first user, by the first robot;
transmitting information based on the user input to the server system, by the first robot;
determining a second robot for supporting a task corresponding to the service request, by the server system;
making a request to the second robot for the task, by the server system; and
performing the task, by the second robot.

2. The method of claim 1, wherein, in the making the request, the server system transfers previous shopping information of the first user to the second robot, and in performing the task, the second robot moves based on the previous shopping information of the user.

3. The method of claim 1, further comprising:
checking user information corresponding to the identification information of the first user from a database, by a first server of the server system; and
transferring the user information to a second server of the server system, by the first server,
wherein the second server determines the second robot and transfers previous shopping information of the first user to the second robot.

4. The method of claim 1, further comprising:
moving the second robot to a place in which the first robot is positioned.

5. The method of claim 1, further comprising:
moving the second robot to a waiting place based on previous shopping information of the first user.

6. The method of claim 5, further comprising:
outputting a guidance message providing guidance to a waiting place of the second robot, by the first robot.

7. The method of claim 5, further comprising:
outputting, by the first robot, a guidance message indicating a current waiting state of the second robot when the second robot stands by at the waiting place for a task for supporting shopping of the first user and the first robot receives a predetermined user input from a second user.

8. The method of claim 5, wherein the making the request includes further transmitting identification image information identifying the first user to the second robot, by the server system.

9. The method of claim 8, further comprising:
obtaining the identification image information by capturing image data by a camera of the first robot and transmitting the image data to the server system by the first robot, or obtaining image data registered in the server system by the first user.

10. The method of claim 1, further comprising:
providing guidance of predetermined shopping information to the first user, by the first robot; and
moving a shopping article of the first user by the second robot.

11. A method of controlling a robot system, the method comprising:
outputting a first guidance message providing guidance of recommended shopping information, by a first robot;
receiving user input making a service request based on the recommended shopping information from a first user, by the first robot;
transmitting information based on the user input to a server system, by the first robot;
determining a second robot for supporting a task corresponding to the service request, by the server system;
making a request to the second robot for the task, by the server system; and
performing the task, by the second robot,
wherein, in the performing the task, the second robot moves based on the recommended shopping information.

12. The method of claim 11, further comprising:
moving the second robot to a place in which the first robot is positioned.

13. The method of claim 11, further comprising:
moving the second robot to a waiting place based on the recommended shopping information.

14. The method of claim 13, further comprising:
outputting a second guidance message for providing guidance to the waiting place of the second robot, by the first robot.

15. The method of claim 13, further comprising:
outputting a third guidance message indicating a current waiting state of the second robot when the second robot stands by at the waiting place for a task for supporting shopping of the first user and the first robot receives a predetermined user input from a second user.

16. The method of claim 11, wherein the making the request includes further transmitting identification image information for identifying the first user to the second robot, by the server system.

17. The method of claim 16, further comprising:
obtaining the identification image information by capturing image data by a camera of the first robot and transmitting the image data to the server system, by the first robot or obtaining image data registered in the server system by the first user.

18. The method of claim 11, wherein the second robot moves while carrying a shopping article of the first user.

19. A method of controlling a robot system, the method comprising:
receiving user input including a shopping cart service request from a user, by a first robot;
determining a second robot for supporting a task corresponding to the service request, by the first robot;
making a request to the second robot for the task, by the first robot; and
performing the task, by the second robot,
wherein, in the making the request, the first robot transfers recommended shopping information or previous shopping information of the user to the second robot, and
wherein in the performing the task, the second robot moves based on the recommended shopping information or the previous shopping information of the user.

20. The method of claim 19, further comprising:
moving the second robot to a waiting place based on the recommended shopping information or based the previous shopping information of the user.
